(19) United States
(12) Patent Application Publication
(10) Pub. No.: US 2008/0074490 A1
(43) Pub. Date: Mar. 27, 2008

(54) Stereoscopic image display apparatus

(76) Inventors: Tatsuo Saishu, Tokyo (JP); Rieko Fukushima, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/902,095

(22) Filed: Sep. 19, 2007

(30) Foreign Application Priority Data
Sep. 26, 2006 (JP) 2006-260831

(51) Int. Cl. H04N 13/04

(52) U.S. Cl. 348/51; 348/E13.075

(57) ABSTRACT

A stereoscopic image display apparatus includes: an elemental image display part including pixels arranged in a matrix form in a display plane; and an optical plate formed by arranging optical apertures installed so as to be opposed to the elemental image display part and prolonged in a straight line manner substantially in a vertical direction, periodically substantially in a horizontal direction. A horizontal pitch of the optical plate is shorter than n×(m−1)/m times a horizontal pitch of the pixels, a distance L' from a plane of the optical plate at which a light ray group from pixels of every n columns converges is longer than a standard viewing distance L, and a multi-visual-point image of at least (n+2) visual points which is a perspective projection corresponding to the standard viewing distance L is divided and disposed in elemental images in the elemental image display part.

### CROSS-REFERENCE TO RELATED APPLICATION

This application is based upon and claims the benefit of priority from prior Japanese Patent Application No. 2006-260831 filed on Sep. 26, 2006 in Japan, the entire contents of which are incorporated herein by reference.

### BACKGROUND OF THE INVENTION

1. Field of the Invention

The present invention relates to a stereoscopic image display apparatus.

2. Related Art

Various schemes are known as a stereoscopic image display apparatus capable of displaying a moving picture, i.e., the three-dimensional display. In recent years, demand especially for.a scheme that uses a flat panel type and that does not need dedicated glasses is increasing. A scheme of installing an optical plate, which controls a light ray emitted from a display panel and which directs the light ray to a viewer, immediately before a display panel (elemental image display part) fixed in pixel position, such as a direct view or projection type liquid crystal display apparatus or plasma display apparatus, is known as a scheme which can be implemented with comparative ease.

Typically, the optical plate is also called parallax barrier. The optical plate controls the light ray so as to make different images seen depending upon the angle even if the position on the optical plate is the same. Specifically, when only lateral parallax (horizontal disparity) is given, a slit array or a lenticular sheet (cylindrical lens array) is used. When vertical parallax (vertical disparity) is also included, a pinhole array or a lens array is used. Schemes using the parallax barrier are also further classified into binocular, multiview, super-multiview (super-multiview condition of super-multiview), and integral photography (hereafter referred to as IP as well). A basic principle of them is substantially the same as that used in a stereoscopic photograph invented approximately 100 years ago. In some cases, the integral photography is called integral imaging, integral videography or the like.

In both the IP and multiview, the viewing distance is typically finite. Therefore, a display image is generated so as to cause a perspective projection image in the viewing distance to be actually seen. In the IP (one-dimensional IP) having only horizontal disparity and having no vertical disparity, there are a set of parallel light rays (hereafter also referred to as parallel light ray one-dimensional IP) if the pitch in the horizontal direction of the parallax barrier is an integer times of the pitch in the horizontal direction of sub-pixels in the elemental image display part. Therefore, a stereoscopic image of proper projection is obtained by dividing an image having a perspective projection of a certain constant viewing distance in its vertical direction and an orthographic projection in its horizontal direction into pixel columns and compounding them into a parallax interleaved image which is the image form displayed on a display plane. Its concrete method is disclosed in SID04 Digest 1438 (2004). In the multiview, a stereoscopic image of proper projection is obtained by dividing an image obtained by simple perspective projection and disposing resultant images.

By the way, it is difficult to implement an imaging apparatus in which the projection method or the projection central distance is made different according to whether the direction is the vertical direction or the horizontal direction, because a camera or a lens having the same size as that of the subject is needed especially in the case of the orthographic projection. For obtaining orthographic projection data by shooting, therefore, a method of converting shooting data of the perspective projection is realistic. The light ray space method which is a method using interpolation with EPI (epipolar plane) is known.

As disclosed in SID04 Digest 1438 (2004), the parallel light ray one-dimensional IP has a merit that the viewing zone is wide, the motion parallax is continuous, natural and easy to see as compared with the binocular or the multiview.

Since the binocular and the multiview are the simplest stereoscopic image display, the image format is simple and all visual point images are the same in size. Two parallax component images, in the case of binocular, or nine parallax component images, in the case of nine-viewpoint, should be divided every pixel column, and resultant images should be compounded into a parallax interleaved image which is an image form displayed in the elemental image display part. In the parallel light ray one-dimensional IP, the number of parallax component images is large as compared with the multiview having an equivalent resolution, and the size of the parallax component image (horizontal range in use) also differs depending upon the parallax direction. In the case of computer graphics (CG), the image processing speed depends upon the number of cameras as well. In the case of the shot image, the cost of the imaging apparatus becomes high if the number of actual cameras is large. Also in the case where the number of actual cameras is decreased and the number of cameras for interpolation between visual points is increased, the processing load becomes high.

As described above, the conventional parallel light ray one-dimensional IP stereoscopic image display apparatus has a problem that the processing speed is lowered because the number of necessary visual points is large.

### SUMMARY OF THE INVENTION

The present invention has been made in view of these circumstances, and an object of thereof is to provide a stereoscopic image display apparatus, and display method capable of preventing the processing speed from lowering without hampering the picture quality.

A stereoscopic apparatus according to a first aspect of the present invention includes: an elemental image display part including pixels arranged in a matrix form in a display plane; and

an optical plate formed by arranging optical apertures installed so as to be opposed to the elemental image display part and prolonged in a straight line manner substantially in a vertical direction, periodically substantially in a horizontal direction,

wherein

a horizontal pitch of the optical plate is shorter than n×(m−1)/m times a horizontal pitch of the pixels, where 2 m represents a total number of pixel columns and n represents an integer,

a distance L′ from a plane of the optical plate at which a light ray group from pixels of every n columns converges is longer than a standard viewing distance L, and

a multi-visual-point image of at least (n+2) visual points which is a perspective projection corresponding to the standard viewing distance L is divided and disposed in elemental images in the elemental image display part.

A stereoscopic apparatus according to a second aspect of the present invention includes: an elemental image display part including pixels arranged in a matrix form in a display plane; and

an optical plate formed by arranging optical apertures installed so as to be opposed to the elemental image display part and prolonged in a straight line manner substantially in a vertical direction, periodically substantially in a horizontal direction,

wherein

a horizontal pitch of the optical plate is shorter than n×(m−1)/m times a horizontal pitch of the pixels, where 2 m represents a total number of pixel columns and n represents an integer,

a distance L′ from a plane of the optical plate at which a light ray group from pixels of every n columns converges is longer than a standard viewing distance L, and

a multi-visual-point image at n visual points having a perspective projection corresponding to the viewing distance L in a vertical direction and a perspective projection corresponding to the distance L′ in the horizontal direction is divided and disposed in elemental images in the elemental image display part.

A stereoscopic apparatus according to a third aspect of the present invention includes: an elemental image display part including pixels arranged in a matrix form in a display plane; and

an optical plate formed by arranging optical apertures installed so as to be opposed to the elemental image display part and prolonged in a straight line manner substantially in a vertical direction, periodically substantially in a horizontal direction,

wherein

a horizontal pitch of the optical plate is shorter than n−(m−1)/m times a horizontal pitch of the pixels, where H represents a height of the elemental image display part, 2 m represents a total number of pixel columns and n represents an integer, and

a distance L′ from a plane of the optical plate at which a light ray group from pixels of every n columns converges is longer than 6 H.

### BRIEF DESCRIPTION OF THE DRAWINGS

FIG. 1 is a horizontal section view showing a one-dimensional IP stereoscopic image display apparatus, and display method, according to an embodiment;

FIG. 2 is a plan view showing a one-dimensional IP stereoscopic image display apparatus, and display method, according to an embodiment;

FIG. 3 is a plan view showing a strict parallel light ray one-dimensional IP stereoscopic image display apparatus, and display method, according to a comparative example;

FIG. 4 is a plan view showing a multiview stereoscopic image display apparatus, and display method, according to a comparative example;

FIG. 5 is a plan view showing a one-dimensional IP stereoscopic image display apparatus, and display method, according to an embodiment;

FIG. 6 is a horizontal section view showing a one-dimensional IP stereoscopic image display apparatus, and display method, according to an embodiment;

FIG. 7 is a horizontal section view showing a strict parallel light ray one-dimensional IP stereoscopic image display apparatus, and display method, according to a comparative example;

FIG. 8 is a horizontal section view showing a multiview stereoscopic image display apparatus, and display method, according to a comparative example;

FIGS. 9A and 9B are tables for explaining reduction of the number of cameras according to an embodiment;

FIGS. 10A and 10B are oblique views schematically showing an optical plate according to an embodiment;

FIG. 11 is an oblique view schematically showing a stereoscopic image display apparatus used for stereoscopic image display according to an embodiment;

FIGS. 12(a), (b), and (c) are schematic diagrams showing relations among an elemental image pitch Pe, a parallax barrier pitch Ps, a gap d, a viewing distance L and a viewing width W in a stereoscopic image display apparatus;

FIG. 13 is a table showing a data range and a disposition location in a parallax interleaved image, of each parallax component image in a stereoscopic image display apparatus;

FIGS. 14A and 14B are schematic diagrams showing a projection method of each parallax component image according to an embodiment;

FIG. 15 is a schematic diagram showing an image construction method according to an embodiment;

FIG. 16 is an oblique view schematically showing a pixel arrangement in a stereoscopic image display apparatus used in stereoscopic image display according to an embodiment;

FIG. 17 is a front view schematically showing a pixel arrangement and a parallax image disposition in a stereoscopic image display apparatus used in stereoscopic image display according to an embodiment;

FIG. 18 is a front view schematically showing a pixel arrangement and a parallax image disposition in a stereoscopic image display apparatus used in stereoscopic image display according to an embodiment;

FIG. 19 is a schematic diagram showing position relations among pixels, an elemental image and a parallax barrier of the one-dimensional IP according to an embodiment;

FIG. 20 is a schematic diagram showing position relations among pixels, an elemental image and a lenticular sheet of the one-dimensional IP according to an embodiment;

FIG. 21 is a schematic diagram showing an image disposition method in a one-dimensional IP stereoscopic image display apparatus according to an embodiment;

FIG. 22 is a schematic diagram showing an image disposition method in a one-dimensional IP stereoscopic image display apparatus according to an embodiment; and

FIG. 23 is a plan view showing a camera disposition in a stereoscopic image display method according to an embodiment.

### DETAILED DESCRIPTION OF THE INVENTION

Hereafter, stereoscopic image display apparatuses according to embodiments of the present invention will be described in detail with reference to the drawings. In the present specification, “pixel” indicates a minimum unit which can be controlled in luminance independently in one frame on a display plane of an elementary image display part. In the ordinary direct-view transmission type liquid crystal panel, the “pixel” corresponds to red (R), green (G) and blue (B) sub-pixels.

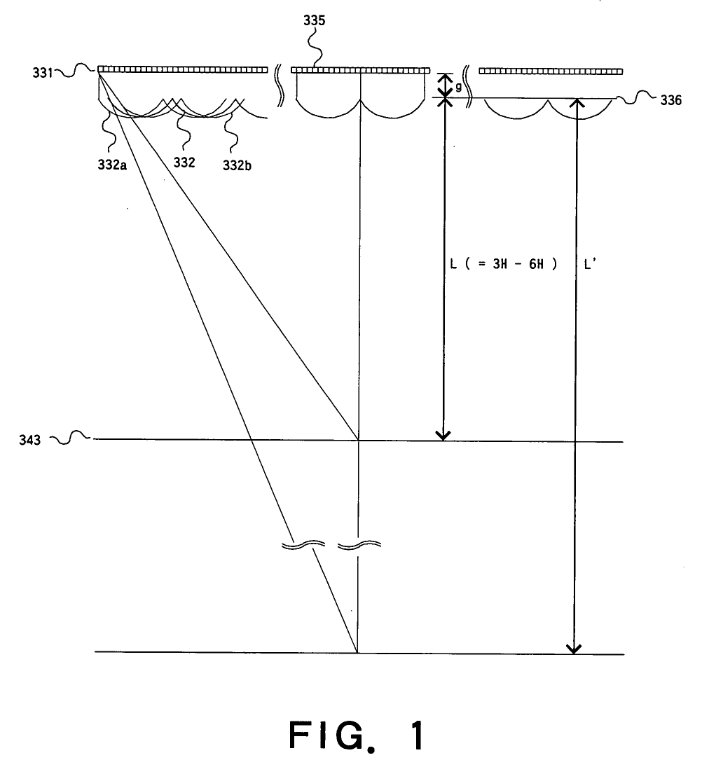

FIG. 1 is a concept diagram representing a horizontal section and an observation position in a stereoscopic image display apparatus according to an embodiment of the present invention. In FIG. 1, the number (n) of parallaxes is 12. The stereoscopic image display apparatus includes an elemental image display part 331 having pixels 335 arranged in a matrix form in the display plane, and a lenticular sheet (optical plate) 332 obtained by arranging cylindrical lenses installed so as to be opposed to the elemental image display part 331 and prolonged in a straight line manner substantially in the vertical direction, periodically substantially in the horizontal direction.

In a strict parallel light ray one-dimensional IP stereoscopic image display apparatus, the position of the lens at both ends of the screen is indicated by 332a and the horizontal lens pitch is twelve times pixel width. Since a light ray group from pixels of every n columns has parallel light rays, the converging distance is infinitely remote. On the other hand, in the stereoscopic image display apparatus according to the present embodiment, the horizontal pitch of the lenses 332 is substantially equivalent to twelve pixels, but it is slightly shorter than twelve pixels and there are lens ends in positions displaced from ends of the screen by two pixels. In other words, when the number of parallaxes is n and the total number of pixel columns is 2 m, the horizontal pitch of the optical plate 332 is n ×(m−2)/m times the horizontal pitch of pixels. The distance at which the light ray group from pixels of every n columns converges is L′ shown in FIG. 1. If the viewing distance L is in the range of 3 H to 6 H in the same way as the standard display (see, for example, CCIR recommendations 500-2) where H is the height of the elemental image display part 331, L′ is greater than L. If the light ray group from pixels of every n columns converges at L, the scheme is multiview and the lens position at both ends of the screen (upper limit of the horizontal lens pitch) becomes 332b. In other words, in the multiview, the lens pitch becomes shorter than that in the stereoscopic image display apparatus according to the present embodiment. By the way, the viewing distance is measured by taking the optical plate plane as the reference. Strictly speaking, however, a lens principal plane 336 of the optical plate is taken as the reference. As compared with the viewing distance, however, the difference in position between the optical plate plane and the lens principal plane is negligibly small, and they can be regarded as the same.

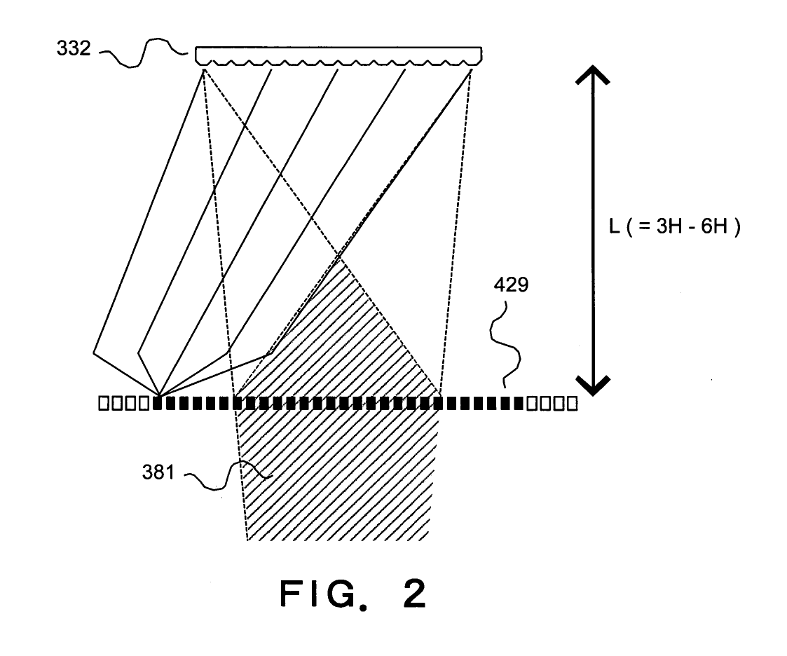

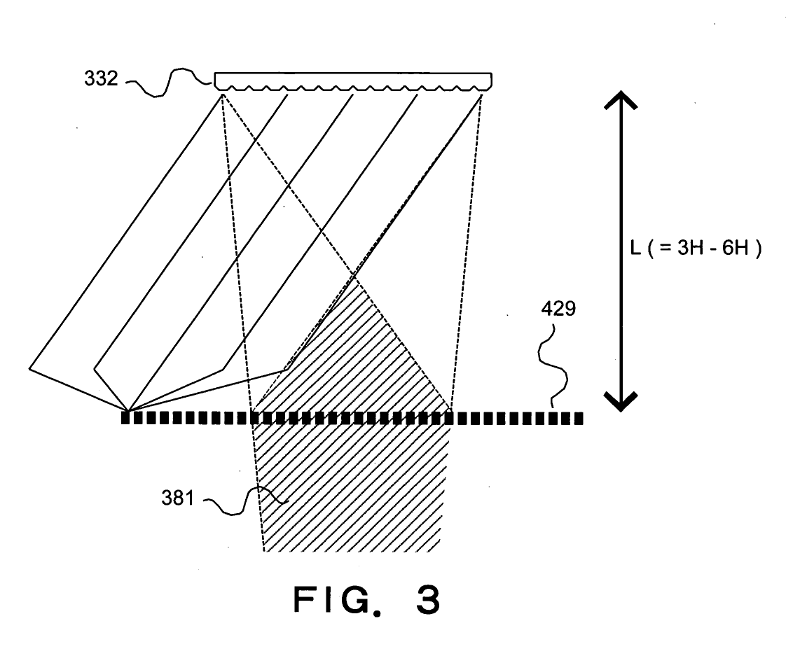

The number of required cameras in the parallel light ray one-dimensional IP will now be described with reference to FIGS. 2 to 4. FIGS. 2 to 4 are diagrams respectively representing the stereoscopic image display apparatus according to the present embodiment, the strict parallel light ray one-dimensional IP stereoscopic image display apparatus (comparative example), and the multiview stereoscopic image display apparatus (comparative example) by using a plan view which indicates the display plane, a viewing zone 381 and light rays. The lens pitch as compared with the pixel pitch becomes short in the order of the strict parallel light ray one-dimensional IP→the present embodiment→the multiview, and light ray group from pixel columns of every n-th pixel converges. The shaded part 381 is the viewing zone, and solid lines represent a light ray group from a pixel column of every n-th pixel, i.e., a light ray group corresponding to one camera. In the case of a light ray group akin to the parallel light ray group, the light ray group is drawn to converge to a camera from the vicinity of the camera so as to exhibit association with the camera. Among cameras 429, a “required camera” represented by a black square is a camera, light rays corresponding to which are contained in the viewing zone even partially. A “reduced camera” represented by a white square is a camera, light rays corresponding to which are not contained in the viewing zone.

In general, the number of required cameras in the parallel light ray one-dimensional IP becomes a number obtained by adding twice (corresponding to both sides) the number of cameras which increase on one side of the viewing zone to the number of parallaxes, because the number of pixels protruded from the corresponding lens in an endmost elemental image becomes the number of cameras which increase on one side of the viewing zone. If the endmost elemental image is an endmost image having a number of pixel columns which is one larger than the number of parallaxes and at least one pixel is protruded from the screen, however, the number of protruded pixels minus 1 is the number of cameras which increase on one side. By the way, the disposition of the elemental image is laterally symmetrical about the center of the screen. Denoting an elemental image average pitch with the pixel width taken as the unit by Pe and a function representing a maximum integer (in this case, “a” is limited to a>0) which does not exceed “a” by INT(a), the number of required cameras becomes:
INT(INT(m/Pe)×(Pe−n)+0.5)×2+n

Denoting an air conversion distance between the lens principal plane and a pixel by g (shown in FIG. 1), the elemental image average pitch (with the pixel width taken as the unit) is:
Pe=n(L+g)/L

By the way, in the case of a lenticular sheet inclined obliquely in lens direction, the number of pixels can be calculated as the effective value (for example, in the case of 16 parallaxes with a tilt angle tan⁻¹ (¼), 2 m is 4/3 times the actual number of pixels). The number of parallaxes is restricted to integers.

As appreciated from the foregoing expression, the number of cameras increases or decreases by two because of symmetry. For decreasing the number of cameras by at least two, INT(m/Pe)×(Pe−n) should be decreased by at least 1 by slightly changing Pe. INT(m/Pe) is equal to half the number of lenses, and this is regarded as unchanged even if Pe assumes a change in the range of approximately 0.1 to 0.3%. Eventually, therefore, INT(m/Pe)×Pe should be decreased by at least 1. However, this corresponds to the lens end position measured from the center of the screen by taking the number of pixels as the unit. If the lens pitch is shortened so as to shift the lens end position toward the center of the screen by at least one pixel, therefore, the number of cameras decreases by at least 2. This corresponds to the fact that the horizontal pitch of lenses is smaller than n×(m−1)/m times the horizontal pitch of pixels.

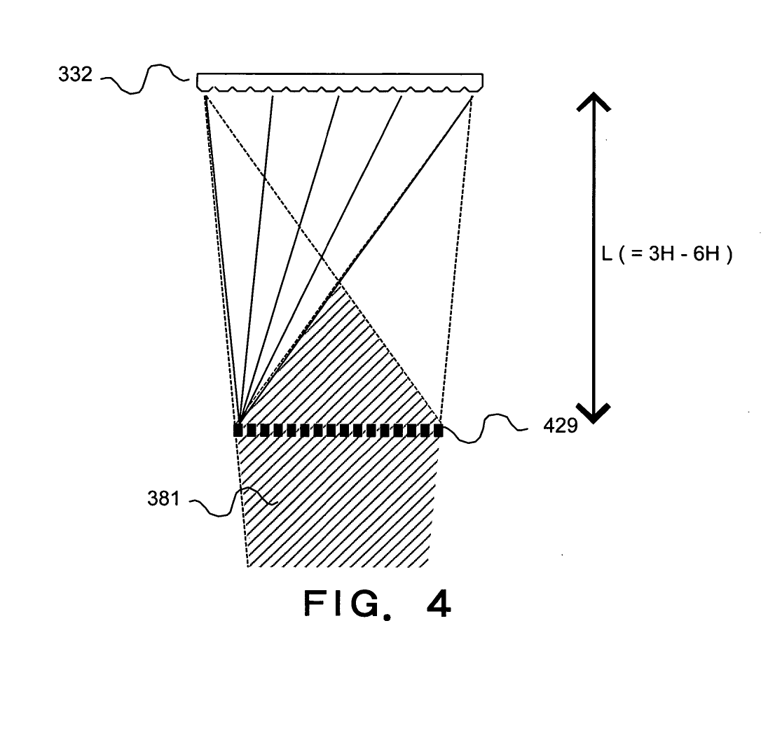

If thus the lens pitch is shortened and the number of cameras is decreased gradually, the number of cameras is minimized in the case of the multiview shown in FIG. 4. In the multiview, however, the light ray distribution is not uniform in the vicinity of a position 343 having a viewing distance L. This results in a problem that moire is apt to be generated and the continuity of the motion parallax is also hampered. As a result, the feature of the parallel light ray one-dimensional IP stereoscopic image is lost. Therefore, the lens end 332 in the present embodiment is located on the outer side than the lens end 332b depending upon the lens pitch in the case of the multiview. The distance from the optical plate plane on which light ray groups from pixels of every n columns converge becomes further longer than the maximum value 6H in the case of the multiview. In other words, a stereoscopic image which exhibits multiview characteristics at a standard viewing distance is not formed.

If an image having orthographic projection in the horizontal direction similar to that in the strict parallel light ray one-dimensional IP is used as each parallax component image (camera image) in the stereoscopic image display apparatus according to the present embodiment shown in FIG. 2, distortion is caused in the stereoscopic image. Contrary to the distortion expanding the near-side part while compressing the far-side part and emphasizing the stereoscopic feeling, this distortion reduces the stereoscopic feeling and it is unfavorable. As for each parallax component image (camera image), therefore, a perspective projection image corresponding to the viewing distance in the range of 3H to 6H should be used. By doing so, distortion which emphasizes the stereoscopic feeling is contained moderately. In both the CG and the shot image, a simple image of perspective projection can be used. Advantageously, therefore, the processing load is not applied.

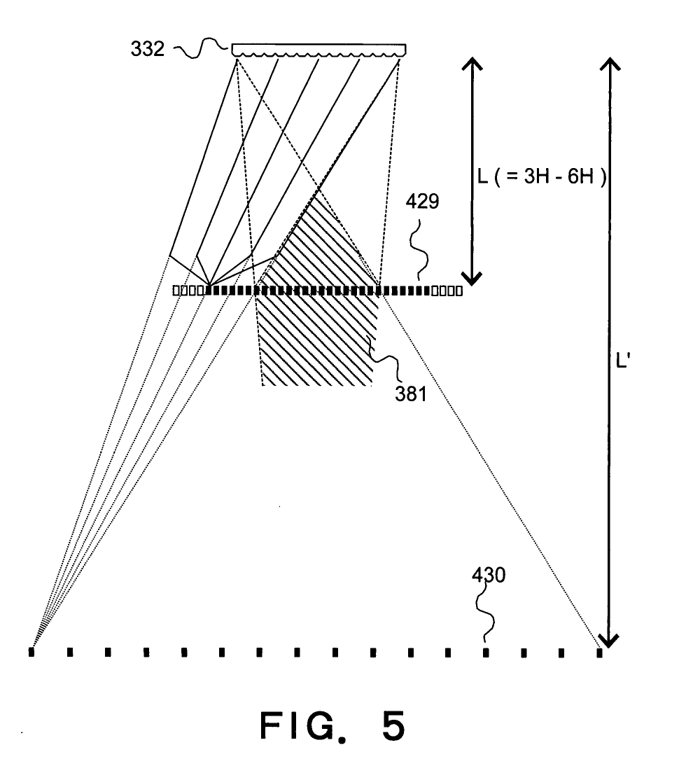

FIG. 5 is a diagram for explaining an image generation and display method used when it is desired to obtain a stereoscopic image free from distortion in the case of the stereoscopic image display apparatus according to the present embodiment as well. A multi-visual-point image at n visual points having a perspective projection corresponding to a viewing distance L in the range of 3H to 6H (corresponding to a camera position 429) in the vertical direction and a perspective projection corresponding to a distance L' at which a light ray group from pixels of every n columns converges (corresponding to a camera position 430) in the horizontal direction should be divided and disposed in elemental images in the same way as the multiview. In this case, the number of cameras is reduced to the same number as that in the multiview. However, it is necessary to change the projection method according to whether the direction is the vertical direction or the horizontal direction. In the case of the CG, association or a model modification in the projection processing becomes necessary. In the case of the shot image, interpolation processing utilizing EPI becomes necessary.

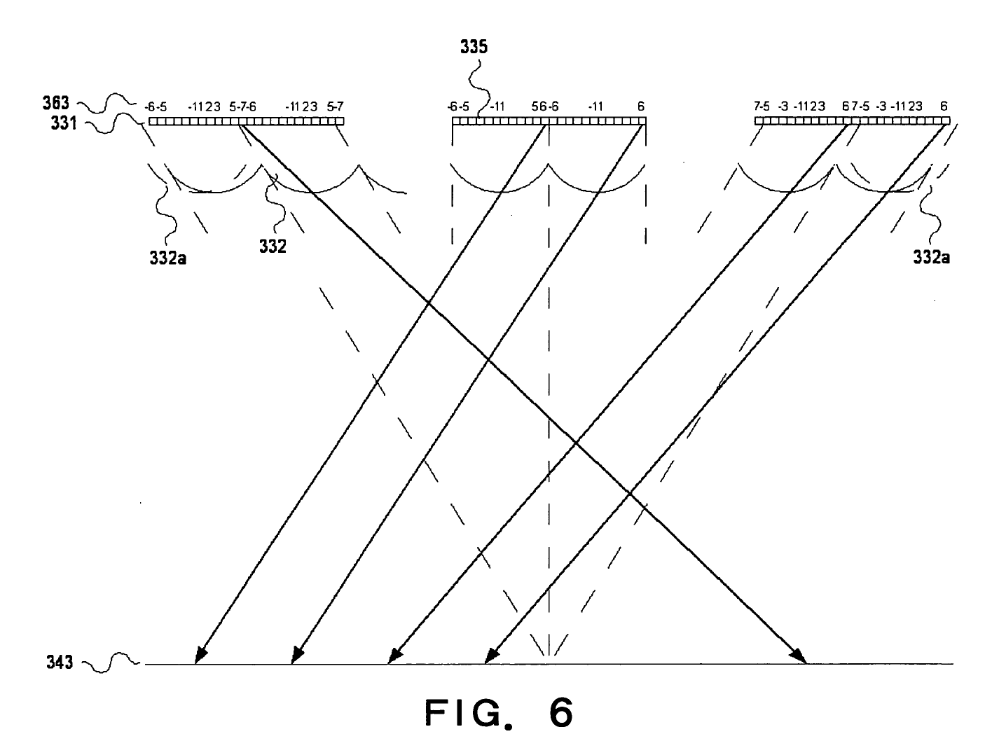

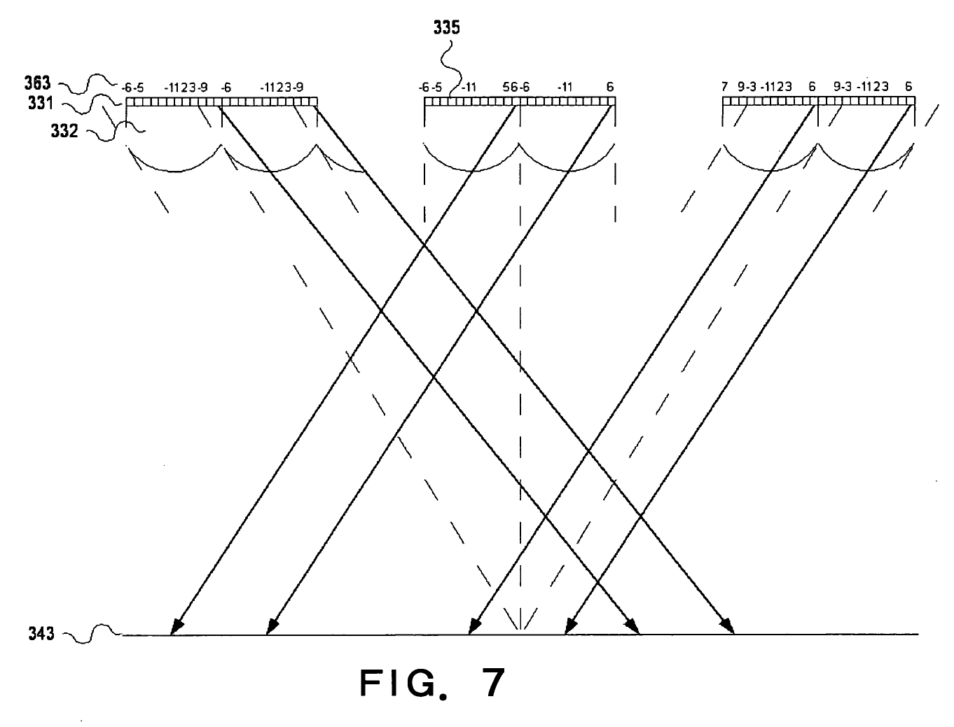

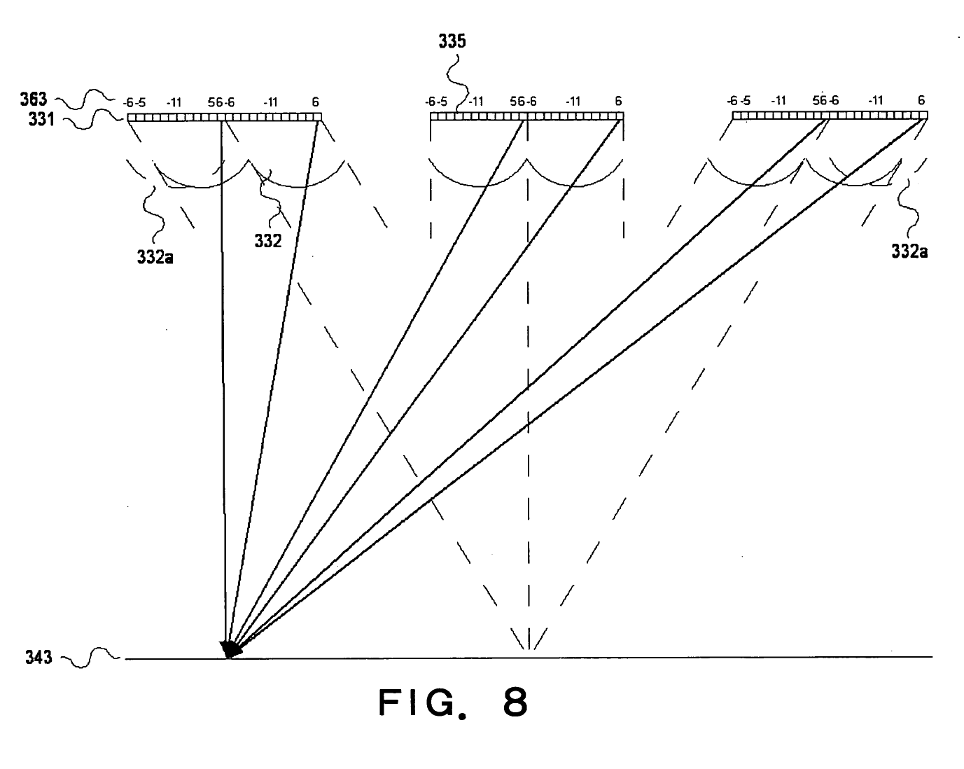

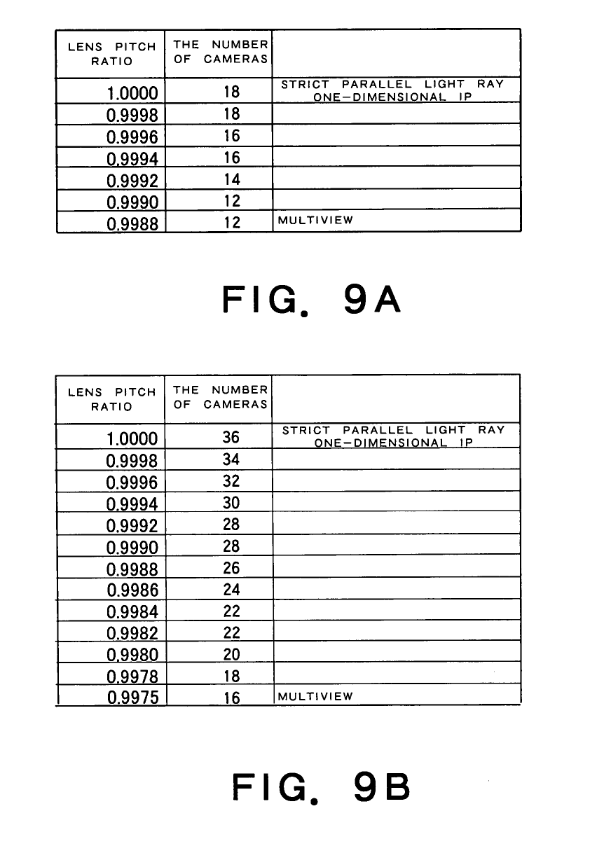

FIG. 6 is a horizontal section view for explaining a concrete example of the present embodiment by comparing it with the strict parallel light ray one-dimensional IP (a comparative example shown in FIG. 7) and the multiview (a comparative example shown in FIG. 8). FIG. 9A shows a corresponding table. In the case of 12 parallaxes, in the parallel light ray one-dimensional IP (FIG. 7), a maximum range of a parallax number (camera number) corresponding to lenses at both ends of the screen is the range of −9 to 9 (except 0) and 18 cameras are needed. FIG. 6 shows the case where the lens pitch is shortened up to a lens pitch ratio 0.9992 in the table shown in FIG. 9A by using the stereoscopic image display apparatus according to the present embodiment. A maximum range of the parallax number (camera number) corresponding to lenses at both ends of the screen is the range of −7 to 7 (except 0), and cameras are reduced to 14 cameras. In the case of the multiview shown in FIG. 8, the number of cameras is 12 and it corresponds to a lens pitch ratio of 0.9988 in FIG. 9A.

FIG. 9B is a table showing an example of reduction of the number of cameras in a 16-parallax stereoscopic image display apparatus having a lens tilt angle tan⁻¹(¼) in the present embodiment. If the viewing distance is set to a short distance equal to 3H or less, especially the number of cameras increases in the parallel light ray one-dimensional IP. In this example, 36 cameras which is at least twice the number of parallaxes are needed. The number of cameras decreases as the lens pitch is shortened. If the lens pitch is set so as to make the number of cameras equal to approximately 26 cameras which is substantially middle between the parallel light ray one-dimensional IP and the multiview, the effect of reduction of the number of cameras is sufficient and the bad influence caused by becoming closer to the multiview characteristics can also be suppressed and hence it can be said to be desirable.

For bodily sensation of the improvement of the actual processing rate such as a difference in frame rate of a moving picture, a frame rate difference of at least 20% can be regarded as necessary. Therefore, it is desirable to set a lens pitch at which the number of cameras is decreased by at least 20%. When using a lenticular sheet made of plastics, it is desirable to use the range of the present embodiment at a standard temperature for use with due regard to the pitch variation caused by a temperature change (thermal expansion) and use at least the lens pitch of the multiview near the lower limit of the supposed temperature in use.

The optical aperture of the optical plate may take an oblique shape, a zigzag shape or a stepwise shape instead of the vertical shape. Furthermore, the pixel arrangement in the display apparatus may be a delta arrangement. In that case as well, it is possible to reduce the number of cameras by conducting the lens pitch setting as in the present embodiment. The distortion in the stereoscopic image is also suppressed by using a suitable projection method as in the present embodiment.

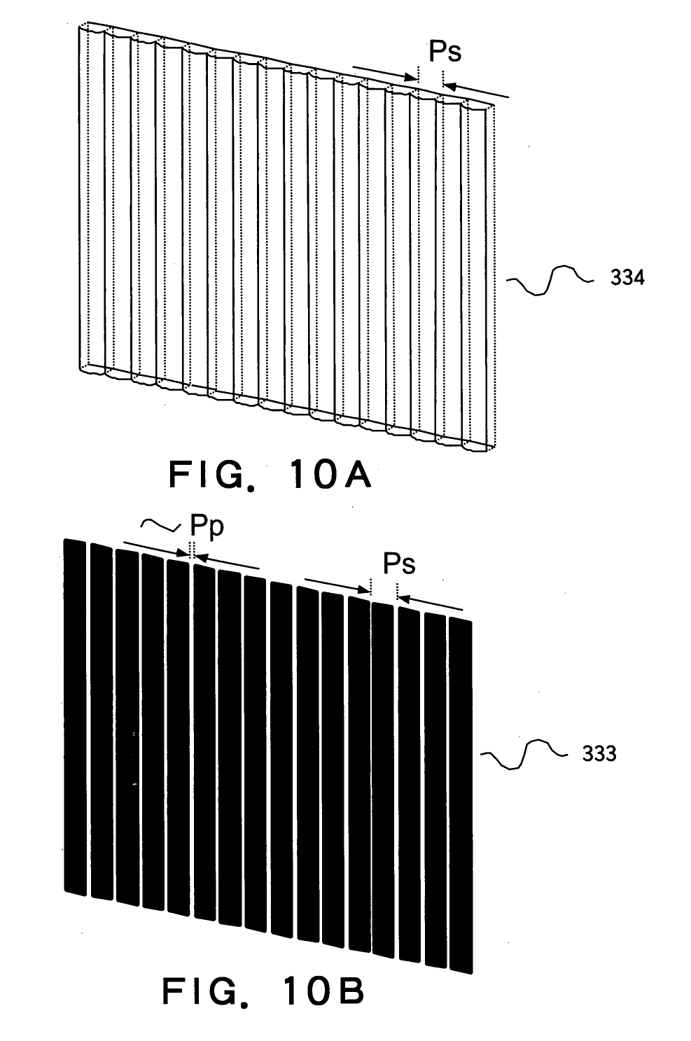

Stereoscopic image display using the IP parallax image disposition will now be described with reference to FIGS. 10A to 23. The stereoscopic image display shown in FIGS. 10A to 23 is implemented in combination with the display apparatus and display method described with reference to FIGS. 1 to 9. Here, FIGS. 10A to 23 become diagrams for explaining an embodiment in the case of 18 parallaxes (n=18) different from FIGS. 1 to 9.

FIG. 10A is an oblique view of a lenticular sheet 334 serving as the optical plate. FIG. 10B is an oblique view of a slit 333 serving as the optical plate.

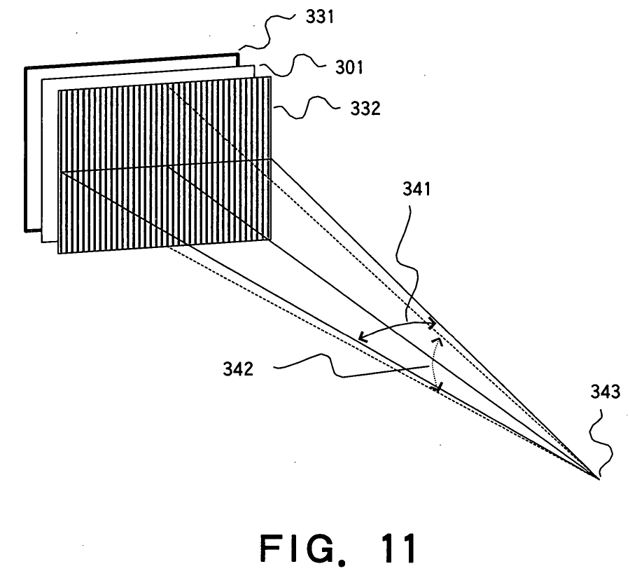

FIG. 11 is an oblique view schematically showing the whole of the stereoscopic image display apparatus. As occasion demands, a diffusion sheet 301 is provided between the planar image display part 331 and the lenticular sheet (optical plate) 332. Viewing from the visual point 343 located at the supposed viewing distance, a stereoscopic image is observed in the range of a viewing angle 341 in the horizontal direction and a viewing angle 342 in the vertical direction. However, parallax is present only in the horizontal direction.

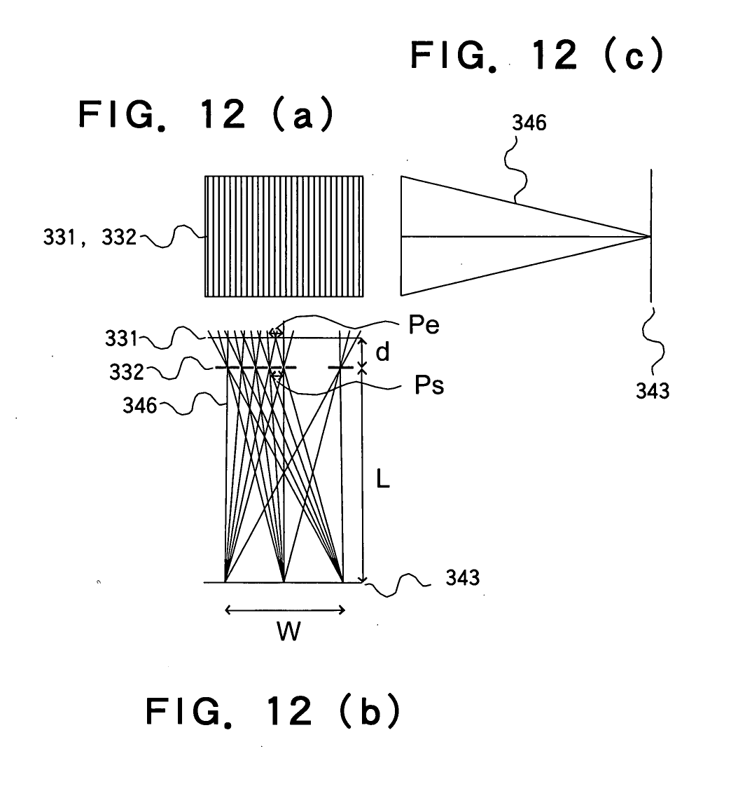

FIGS. 12(a), 12(b) and 12(c) are exploded views schematically showing the light ray reproduction range in the vertical plane and the horizontal plane with the display part in the stereoscopic image display apparatus shown in FIG. 11 taken as the reference. FIG. 12(a) shows a front view of the planar image display part 331 and the parallax barrier 332. FIG. 12(b) shows a plan view showing an image disposition in the stereoscopic image display apparatus. FIG. 12(c) shows a side view of the stereoscopic image display apparatus. The stereoscopic image display apparatus includes the planar image display part (elemental image display part) 331 such as liquid crystal display elements and the optical plate 332 having an optical aperture. The optical plate is formed of the lenticular sheet 334 or the slit array 333 having optical apertures which extend in a straight line manner in the vertical direction and taking the shape of a periodic arrangement in the horizontal direction as shown in FIG. 10A or 10B. In the case of the projection type display part, the optical plate is formed of a curved surface mirror array or the like. Here, the number of pixels in the elemental image display part 331 is, for example, 1920 in the lateral direction (horizontal direction) and 1200 in the longitudinal direction (vertical direction) when counted by taking a square-shaped pixel group of a minimum unit as the unit. The pixel group of each minimum unit contains pixels of red (R), green (G) and blue (B).

If a viewing distance L between the parallax barrier 332 and the viewing distance plane 343, a parallax barrier pitch Ps, a gap (parallax barrier gap) d between the parallax barrier 332 (strictly speaking, its principal plane) and the elemental image display part 331 are defined in FIGS. 12(a), (b) and (c), the elemental image pitch Pe is determined by spacing between the visual point on the viewing distance plane 343 and a projection of the aperture center on the display element. Reference numeral 346 denotes a line coupling the visual point position and each aperture center. A viewing zone width W is determined under the condition that elemental images should not overlap each other on the display plane of the display part 331.

In the one-dimensional IP, the straight line 346 does not pass through the center of each pixel on the display plane of the display part. On the other hand, in the multiview, the line coupling the visual point position and the center of each aperture passes through the pixel center and coincides with the light ray trajectory. If a horizontal pitch Ps of the aperture is an integer times the pixel pitch Pp (strict parallel light ray one-dimensional IP), the elemental image pitch Pe has a fraction by which it is shifted to a larger value from an integer times the pixel pitch Pp. On the other hand, in the multiview, the elemental image pitch Pe becomes an integer times the pixel pitch Pp.

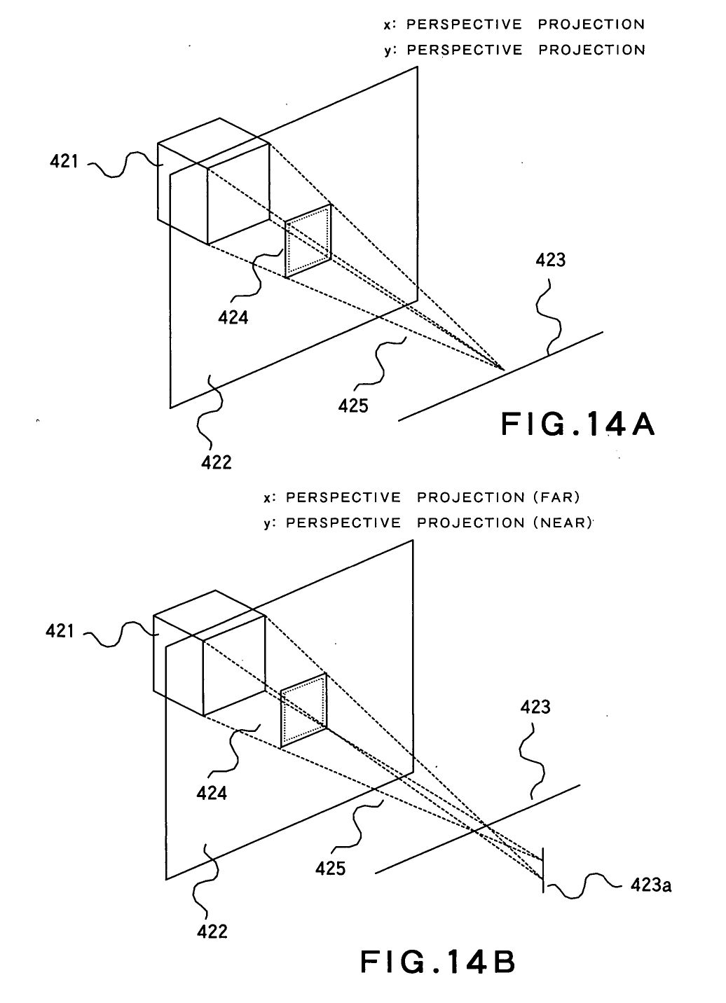

FIGS. 14A and 14B show a method for constructing a one-dimensional IP parallax image, and stereoscopic image, according to an embodiment of the present invention. A displayed substance (subject) 421 is projected onto a projection plane 422 located in the same position as a plane on which the optical plate of the stereoscopic image display apparatus is actually placed.

In FIG. 14A, projection is conducted along projection lines 425 directed toward one point (camera position) on a projection center line 423 which is parallel to the projection plane 422, which is located in front of (in the center in the vertical direction), and which is in the viewing distance plane, so as to perform ordinary perspective projection. By using this projection method, an image 424 of the subject subjected to the perspective projection is generated on the projection plane. Operation is repeated for cameras, and a multi-visual-point image of at least (n+2) visual points which is a perspective projection corresponding to the standard viewing distance L is obtained. By the way, if it is very necessary to suppress the distortion in the stereoscopic image when only the ordinary perspective projection can be used, it is possible to modify a CG model and then use the projection method. In the modification method, the x direction of the near region is compressed and the x direction of the far region is expanded in inverse proportion to the z direction.

In FIG. 14B, projection is conducted along projection lines 425 directed toward a vertical direction projection center line 423 which is parallel to the projection plane, which is located in front of (in the center in the vertical direction) and which is in the viewing distance plane, and toward a horizontal direction projection center line 423a which is parallel to the projection plane, which extends in the vertical direction and which is located father than the viewing distance plane, so as to perform perspective projection which differs in distance according to whether the direction is the vertical direction or the horizontal direction. The projection lines cross in the vertical direction at the vertical direction projection center line 423, and cross in the horizontal direction at the horizontal direction projection center line 423a. By using this projection method, an image 424 of the subject subjected to the special perspective projection is generated on the projection plane. Operation is repeated for cameras, and a multi-visual-point image of n visual points which is a perspective projection corresponding to the distance L′ in the horizontal direction is obtained.

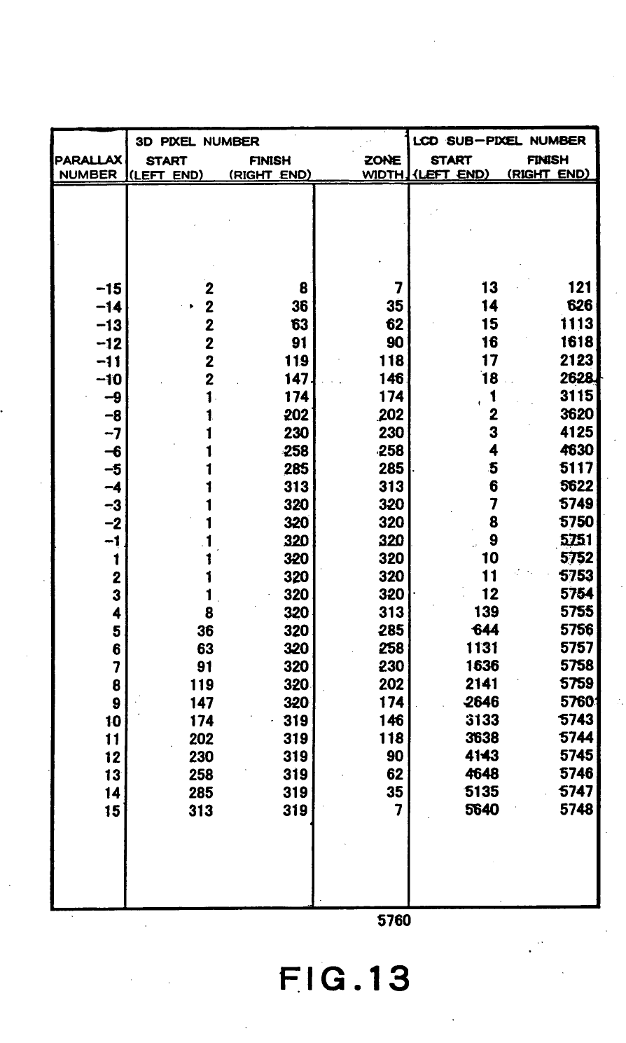

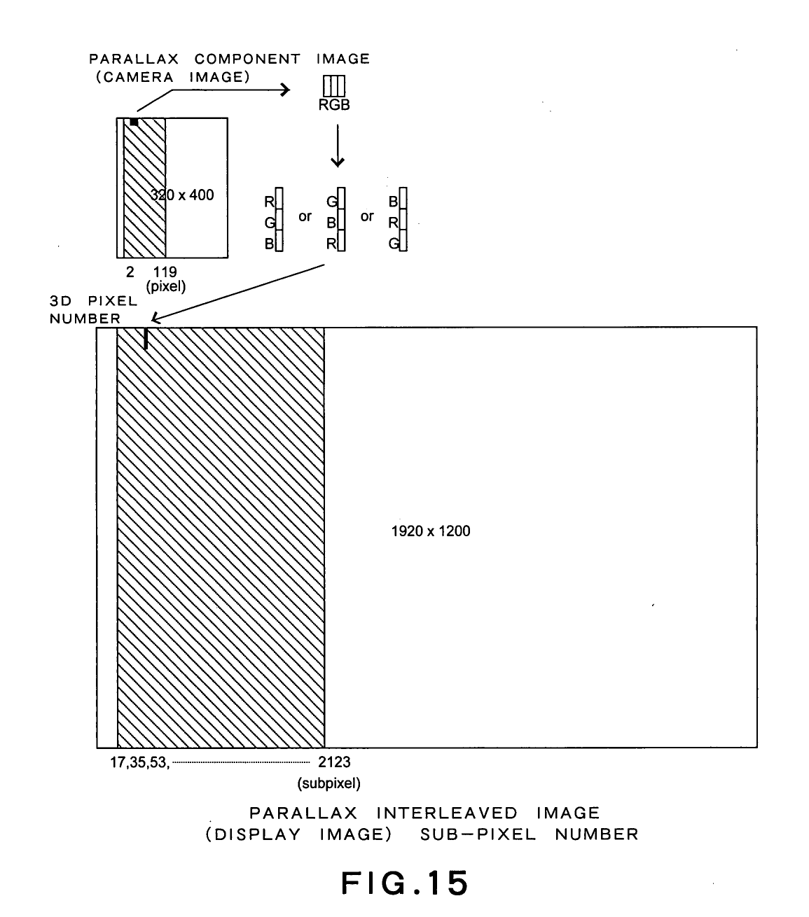

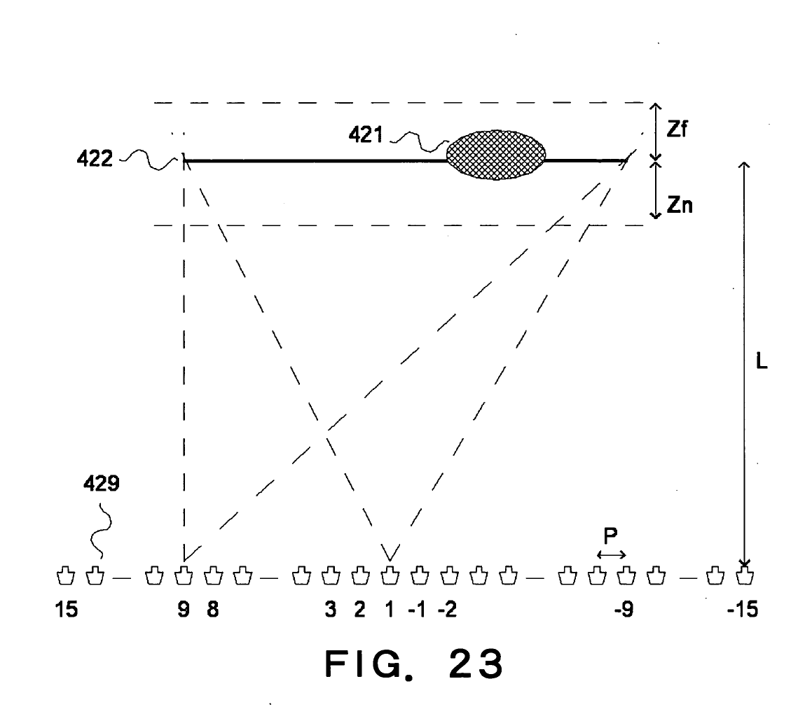

As shown in FIG. 15, images corresponding to one direction (parallax component images) subjected to perspective projection onto the projection plane are divided into pixel columns in the vertical direction, and divisionally disposed on the display plane of the elemental image display part at intervals of the optical aperture pitch of the optical plate (intervals of a definite number of pixel columns). At this time, RGB pixels are rearranged in the longitudinal direction. Operations heretofore described are repeated for other projection directions (cameras) as well, and the whole parallax interleaved image on the display plane is completed. As for the projection directions, several tens directions are needed according to the viewing distance. In the case of the strict parallel light ray one-dimensional IP with a viewing distance of 700 mm, the elemental image width is 18.05 sub-pixel width. According to the present invention, however, the lens pitch is compressed, and the elemental image width is set equal to 18.036 sub-pixel width. In this case, the number of cameras reduces from 34 to 30 in the method shown in FIG. 14A, and the number of cameras is 18 in the method shown in FIG. 14B. In the case of the method shown in FIG. 14A, it suffices that the projected image (parallax component image) generates only columns in the required range, and the required range is shown in FIG. 13. Each projection direction corresponds to a parallax number (camera number). However, the directions are arranged not at equal angle intervals, but at equal intervals on the viewing distance plane. In other words, it is equivalent to shooting while moving cameras in parallel (in a constant direction) on the projection center line at equal intervals. FIG. 23 shows an outline of shooting in the stereoscopic image display method. Cameras 429 arranged in the horizontal direction at equal intervals are adjusted to perform shooting on the projection plane 422.

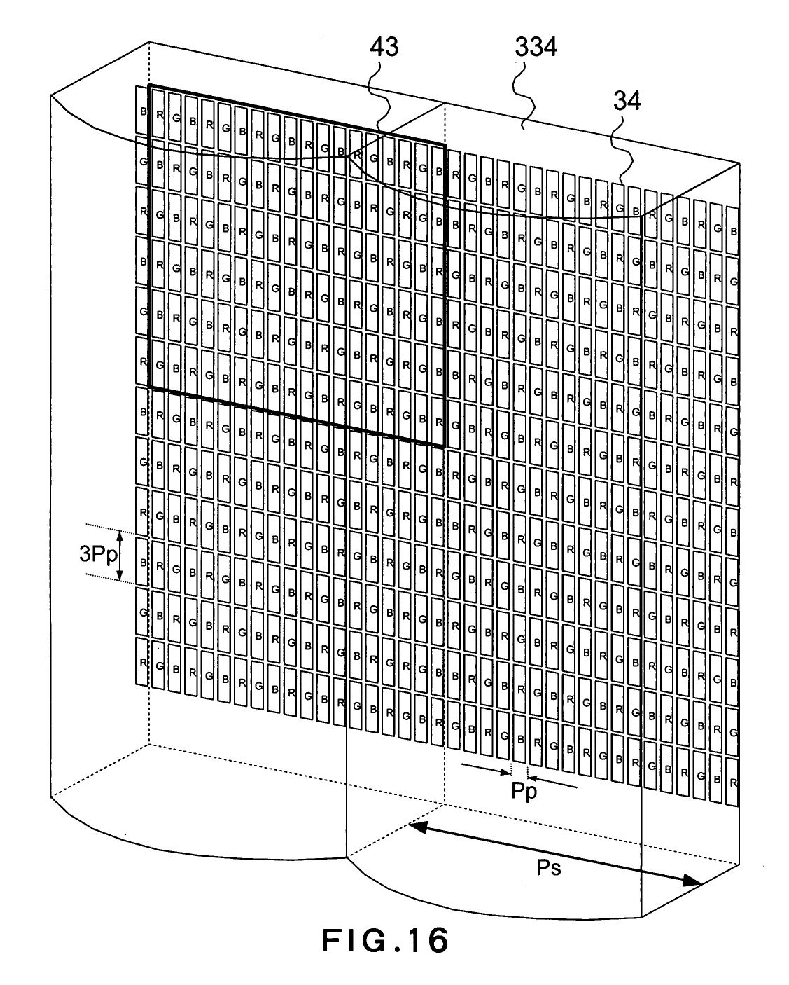

FIG. 16 is an oblique view schematically showing a partial configuration of the stereoscopic image display apparatus. The lenticular sheet 334 formed of a cylindrical lens having an optical aperture which extends in the vertical direction is disposed on a front plane of the display plane of a plane-shaped elemental image display part such as a liquid crystal panel as the optical plate. The optical aperture may be inclined or stepwise. Pixels 34 having an aspect ratio of 3:1 are arranged on the display plane in a straight line manner and a matrix form in the lateral direction and the longitudinal direction. Pixels are arranged in the same row and the same column so as to arrange red, green and blue alternately. This color arrangement is typically called mosaic arrangement.

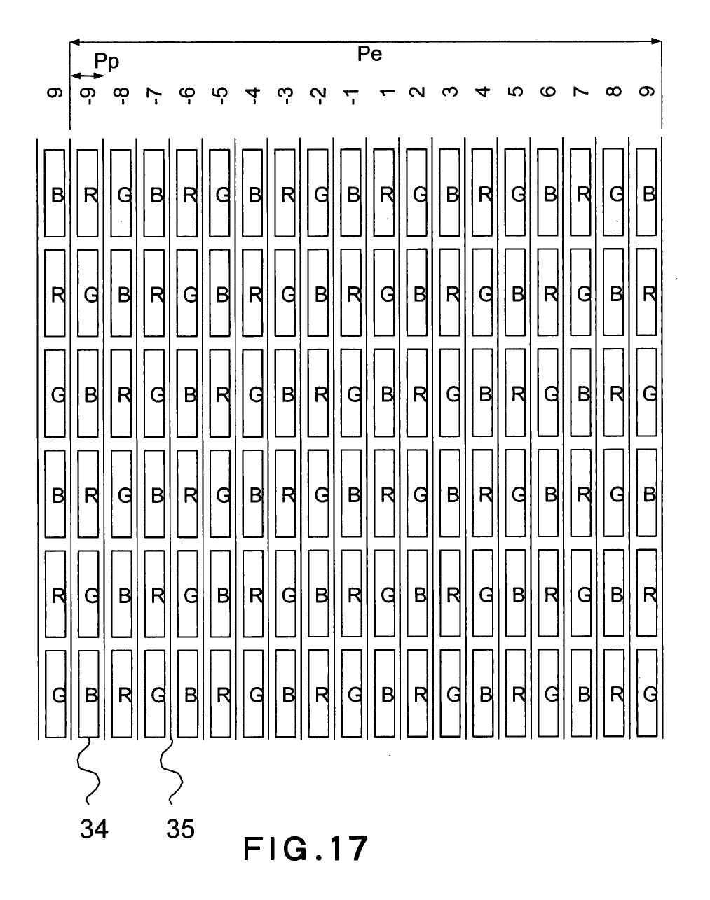

FIG. 17 shows an example of a plan view of the pixel arrangement. Numerals in the range of −9 to 9 represent parallax numbers. Adjacent parallax numbers are assigned to adjacent columns. The longitudinal period of the pixel column is three times the lateral period Rp of pixels. On the display screen shown in FIG. 17, one effective pixel 43 (represented by a black frame in FIG. 16) is formed of pixels 34 in 18 columns and 6 rows or pixels in 18 columns and 3 rows. In the structure of such a display part, stereoscopic image display providing 18 parallaxes in the horizontal direction becomes possible. In this display structure, 18 views are implemented in the case of multiview. The elemental image pitch is 18-pixel pitch, and the lateral pitch of the optical plate becomes smaller than 18-pixel pitch.

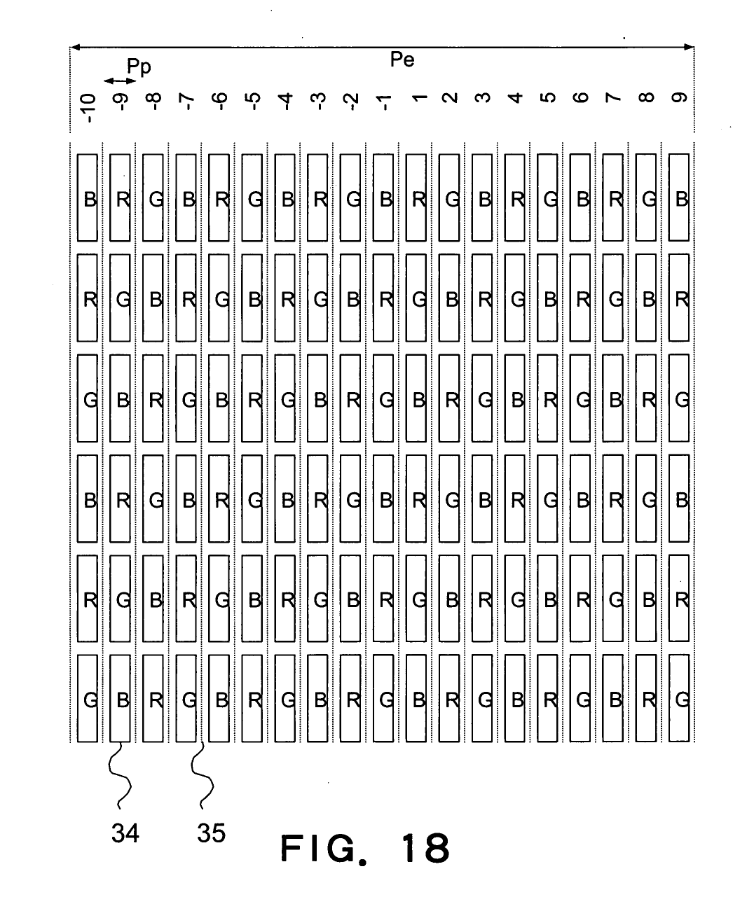

In the case of IP, for example, in a design in which 18-pixel pitch is equal to the parallax barrier pitch Ps and a set of parallel light rays is formed, elemental image boundaries are generated at intervals (for example, 18.05) slightly larger than 18-pixel width. Therefore, the width of the effective pixel corresponds to 18 columns or 19 columns according to the position in the display plane. In other words, the average value of the elemental image pitch is larger than 18-pixel width, and the lateral pitch of the optical plate is 18-pixel width. In the present invention, 18.036 which is middle between the parallel light ray one-dimensional IP and the multiview is set. Although the regenerated light rays are not strict parallel light rays, therefore, the width of partial effective pixels becomes 19 columns. An example of the case where the width of the effective pixels corresponds to 19 columns is shown in FIG. 18. By the way, in the method shown in FIG. 14B, all pixels are handled as a 18-column periodic structure as shown in FIG. 17.

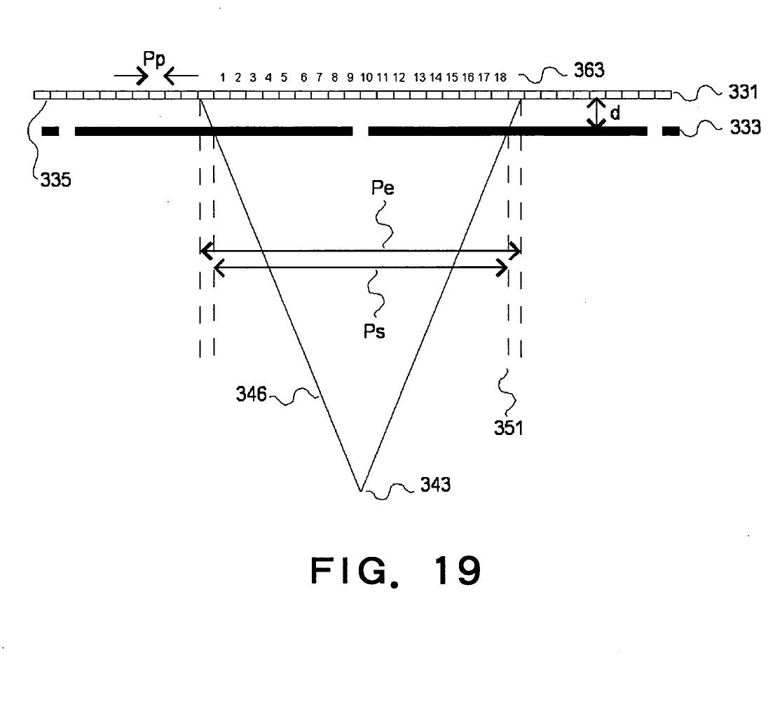

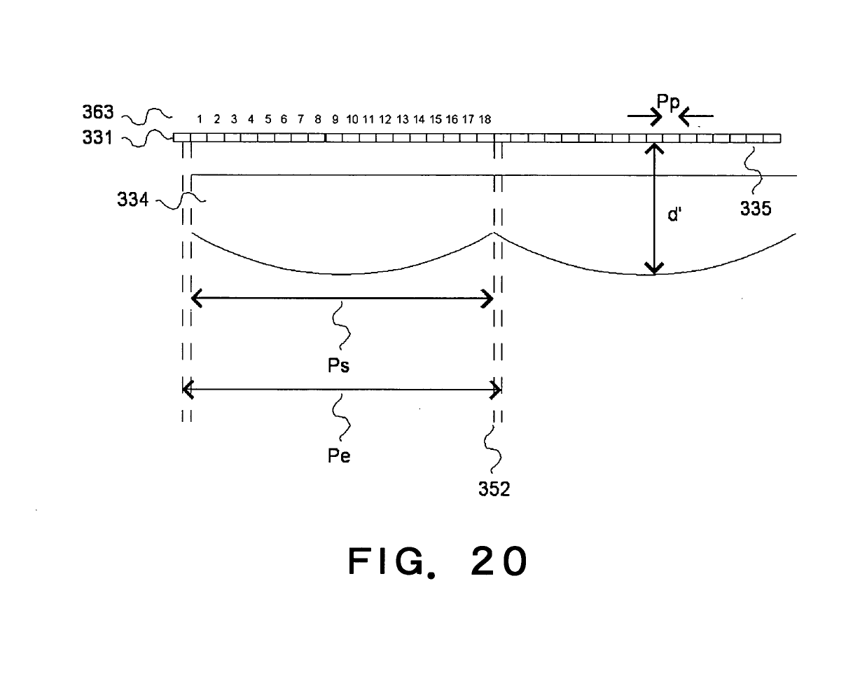

FIG. 19 or 20 schematically shows a horizontal section view of the display part of the stereoscopic image display apparatus. As shown in FIG. 19 or 20, the horizontal pitch Ps (period) of optical aperture in the slit array 333 or the lenticular sheet 334 is determined to become approximately 0.1% smaller than an integer pixel width. In other words, a center axis 351 passing through the center of each slit 332 or a reference axis 352 passing through a boundary between adjacent cylindrical lenses passes substantially through a boundary between pixels in the central part of the screen. As shown in FIG. 1 or 6, however, the center axis 351 or the reference axis 352 gradually deviates from the pixel boundary as the position approaches the left or right end of the screen. Approximately an integer number of pixels are disposed in a region between center axes 351 or reference axes 352, and the pitch Ps (period) in the horizontal direction of the center axis 351 or the reference axis 352 is determined to be definite. In this example, the pitch Ps is set to a value which is approximately 0.1% smaller than 18-pixel width. The gap d between the display plane 331 of the elemental image display part and the parallax barrier 332 or 334 (where air equivalent gap d' corresponds to g shown in FIG. 1) is effectively determined to be approximately 2 mm by considering the refractive index of the glass substrate or the lens material. By the way, reference numeral 343 denotes the viewing distance plane, and reference numeral 363 denotes a number of a parallax component image.

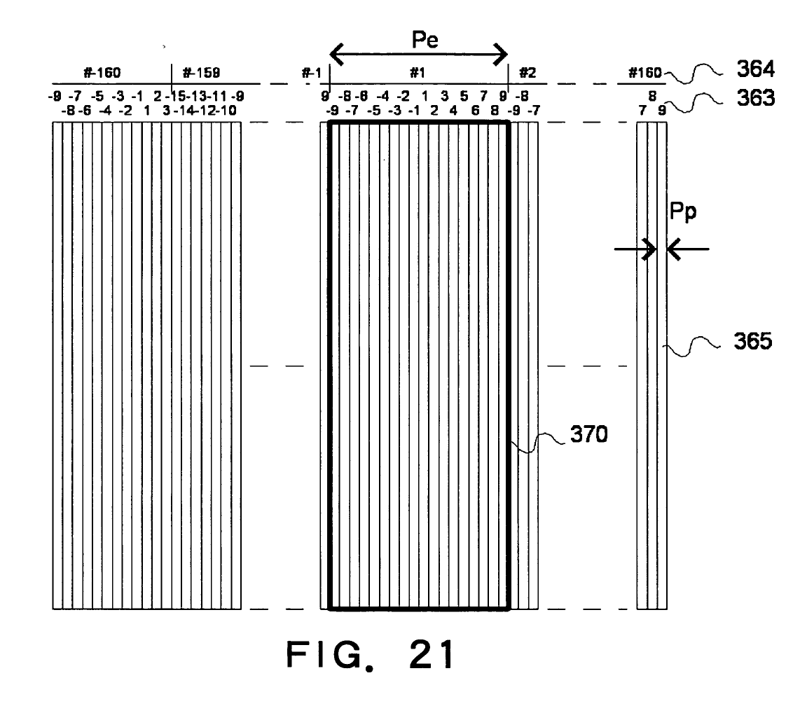

FIG. 21 shows a method of image disposition in the display plane of the elemental image display part of the IP stereoscopic image display apparatus according to an embodiment (the method shown in FIG. 14A) as a concept diagram obtained by viewing the display part from the front. The display plane of the elemental image display part is divided into elemental images 370 corresponding to respective apertures (aperture parts of the optical plate). In the IP, each of the elemental images is formed of pixel columns of 18 columns or 19 columns. The total number of pixel columns which can be subject to parallax assignment is 5760. The number of apertures is 320. (In FIG. 21, the aperture number described in a region denoted by a reference numeral 364 is in the range of #-160 to #-1 and #1 to #160.) Although the aperture pitch Ps is substantially equal to 18-pixel width, it is shorter by approximately 0.1%. For each pixel column 365, a corresponding parallax number (in this example, 30 directions having a parallax number in the range of −15 to −1 and 1 to 15) is indicated in a region denoted by a reference numeral 363. An elemental image having an aperture number #1 is formed of columns of 18 parallaxes having a parallax number in the range of −9 to −1 and 1 to 9. An elemental image having an aperture number #−159 is formed of columns of 18 parallaxes having a parallax number in the range of −15 to −1 and 1 to 3. The elemental image width is slightly larger than the width of 18 pixel columns. If an elemental image boundary is aligned with the nearest pixel column boundary (according to the ordinary A-D conversion method), therefore, the number of pixel columns for an aperture is 18 in most apertures, but the number becomes 19 in some apertures (FIGS. 17 and 18). With an aperture number at which the number of columns becomes 19 serving as a boundary, the parallax number range in the aperture is shifted by one.

In FIG. 13, a lens number (3D pixel number in the table) at which disposition of a parallax image in each direction is started or ended is shown. A column number of a corresponding pixel in the elemental image display part (sub-pixel in the ordinary liquid crystal panel) is also indicated in the table.

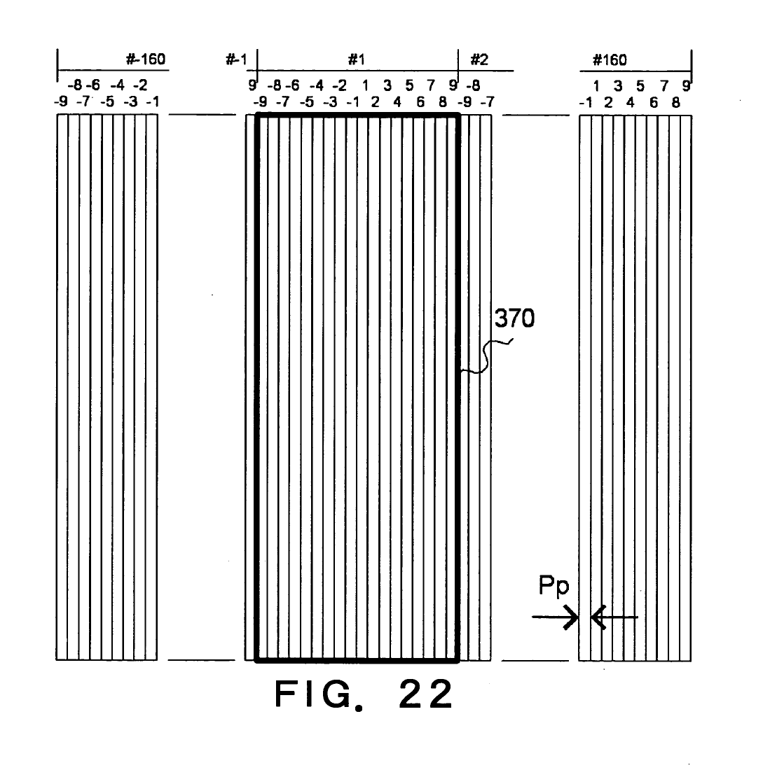

FIG. 22 shows a method of image disposition in the display plane of the elemental image display part of the IP stereoscopic image display apparatus according to an embodiment (the method shown in FIG. 14B) as a concept diagram obtained by viewing the display part from the front. The display plane of the elemental image display part is divided into elemental images 370 corresponding to respective apertures (aperture parts of the optical plate). In the IP, each of the elemental images is formed of pixel columns of 18 columns. The total number of pixel columns which can be subject to parallax assignment is 5760. The number of apertures is 320. (In FIG. 22, the aperture number described in a region denoted by a reference numeral 364 is in the range of #−160 to #−1 and #1 to #160.) Although the aperture pitch Ps is substantially equal to 18-pixel width, it is shorter by approximately 0.1%. For each pixel column 365, a corresponding parallax number (in this example, 18 directions having a parallax number in the range of −9 to −1 and 1 to 9) is indicated in a region denoted by a reference numeral 363. Every elemental image having an aperture number #1 is formed of columns of 18 parallaxes having a parallax number in the range of −9 to −1 and 1 to 9.

According to an embodiment of the present invention, the number of required cameras is reduced by approximately several to ten (several tens per cents) and the processing load is reduced by several tens per cents in the one-dimensional IP, as heretofore described. Especially in the case of 3D-CG software in which required pixel number limiting rendering is impossible or in the case where the viewing distance is short, the effect is great. As for distortion which is a side effect caused by the fact that light rays do not become strictly parallel, the distortion is rather reduced when the ordinary perspective projection image is used as it is.

The present invention is not restricted to the embodiment as it is. In the implementation stage, components can be modified and implemented without departing from the spirit of the invention.

Furthermore, various inventions can be formed by suitably combining a plurality of components disclosed in the embodiment. For example, some components may be removed from all components described in the embodiment. In addition, components striding over different embodiments may be suitably combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A stereoscopic image display apparatus comprising:
an elemental image display part including pixels arranged in a matrix form in a display plane; and
an optical plate formed by arranging optical apertures installed so as to be opposed to the elemental image display part and prolonged in a straight line manner substantially in a vertical direction, periodically substantially in a horizontal direction,
wherein
a horizontal pitch of the optical plate is shorter than n×(m−1)/m times a horizontal pitch of the pixels, where 2 m represents a total number of pixel columns and n represents an integer,
a distance L′ from a plane of the optical plate at which a light ray group from pixels of every n columns converges is longer than a standard viewing distance L, and
a multi-visual-point image of at least (n+2) visual points which is a perspective projection corresponding to the standard viewing distance L is divided and disposed in elemental images in the elemental image display part.

2. A stereoscopic image display apparatus comprising:
an elemental image display part including pixels arranged in a matrix form in a display plane; and
an optical plate formed by arranging optical apertures installed so as to be opposed to the elemental image display part and prolonged in a straight line manner substantially in a vertical direction, periodically substantially in a horizontal direction,
wherein
a horizontal pitch of the optical plate is shorter than n×(m−1)/m times a horizontal pitch of the pixels, where 2m represents a total number of pixel columns and n represents an integer,
a distance L′ from a plane of the optical plate at which a light ray group from pixels of every n columns converges is longer than a standard viewing distance L, and
a multi-visual-point image at n visual points having a perspective projection corresponding to the viewing distance L in a vertical direction and a perspective projection corresponding to the distance L′ in the horizontal direction is divided and disposed in elemental images in the elemental image display part.

3. A stereoscopic image display apparatus comprising:
an elemental image display part including pixels arranged in a matrix form in a display plane; and
an optical plate formed by arranging optical apertures installed so as to be opposed to the elemental image display part and prolonged in a straight line manner substantially in a vertical direction, periodically substantially in a horizontal direction,
wherein
a horizontal pitch of the optical plate is shorter than n×(m−1)/m times a horizontal pitch of the pixels, where H represents a height of the elemental image display part, 2 m represents a total number of pixel columns and n represents an integer, and
a distance L′ from a plane of the optical plate at which a light ray group from pixels of every n columns converges is longer than 6H.
